(19) United States
(12) Patent Application Publication
(10) Pub. No.: US 2013/0265163 A1
(43) Pub. Date: Oct. 10, 2013

(54) Magnetic Field Activated Intrusion Detection

(71) Applicant: Steven R. Joyce, The Colony, TX (US)

(72) Inventor: Steven R. Joyce, The Colony, TX (US)

(73) Assignee: Raytheon Company, Waltham, MA (US)

(21) Appl. No.: 13/156,081

(22) Filed: Jun. 8, 2011

Related U.S. Application Data
(60) Provisional application No. 61/353,072, filed on Jun. 9, 2010.

(51) Int. Cl. G08B 13/22

(52) U.S. Cl. CPC G08B 13/22
USPC 340/551

(57) ABSTRACT

In certain embodiments, an intrusion detection device includes a magnetic field activated sensor and a cascading circuit. The magnetic field activated sensor is operable to detect movement of a corresponding component by sensing a magnetic flux variation of a magnetic device coupled to the component and generate a signal indicating that the corresponding component has moved. The cascading circuit is coupled to the magnetic field activated sensor and is operable to receive the signal generated by the magnetic field activated sensor and to generate a tamper detection signal if the signal indicating that the corresponding component has moved is received or if another tamper detection signal generated by another intrusion detection device is received.

### CROSS-REFERENCE TO RELATED APPLICATION

This application claims the benefit of priority under 35 U.S.C. §119(e) of U.S. Provisional Application Ser. No. 61/353,072, entitled “MAGNETIC FIELD ACTIVATED INTRUSION DETECTION”, filed Jun. 9, 2010.

### GOVERNMENT RIGHTS

This invention was made with Government support via U.S. Government Contract No. W56HZV-05-C-0724 (Future Combat Systems), awarded by the U.S. Department of Defense. The Government may have certain rights in this invention.

### BACKGROUND

Computing systems often include information, such as data, executable programs, or specific types of technological functionality that may be proprietary in nature. In some cases, security of these computing systems may be breached via cyber attack when the computing systems are coupled to communication networks, such as the Internet. In other cases, security of the computing systems may be breached by physical intrusion into their housings to illicitly gather information, or for other purposes.

### SUMMARY

In certain embodiments, an intrusion detection system includes a magnetic field activated sensor and a cascading circuit. The magnetic field activated sensor is operable to detect movement of a corresponding component by sensing a magnetic flux variation of a magnetic device coupled to the component and generate a signal indicating that the corresponding component has moved. The cascading circuit is coupled to the magnetic field activated sensor and is operable to receive the signal generated by the magnetic field activated sensor and to generate a tamper detection signal if the signal indicating that the corresponding component has moved is received or if another tamper detection signal generated by another intrusion detection device is received.

Certain embodiments of the present disclosure may provide one or more technical advantages. For example, certain embodiments of an intrusion detection system sense tampering using changes in magnetic fields and may provide advantages over other tamper detection devices that use mechanically activated switching mechanisms. Certain embodiments may provide intrusion detection devices that are camouflaged or are more difficult to differentiate from other components of the computing system being secured. Thus, certain embodiments may not be disabled by drilling or applying adhesive to inhibit their operation.

Certain embodiments of the present disclosure may provide some, all, or none of these advantages. Certain embodiments may provide one or more other technical advantages, one or more of which may be readily apparent to those skilled in the art from the figures, descriptions, and claims included herein.

### BRIEF DESCRIPTION OF THE DRAWINGS

To provide a more complete understanding of embodiments of the present disclosure and the features and advantages thereof, reference is made to the following description taken in conjunction with the accompanying drawings, in which:

FIG. 1 illustrates one embodiment of a system in which an intrusion detection system may be implemented, according to certain embodiments of the present disclosure;

FIG. 2 illustrates one embodiment of a line-replaceable unit of the system of FIG. 1, according to certain embodiments of the present disclosure;

FIG. 3 illustrates one embodiment of an intrusion detection device that may be utilized in the system of FIG. 1, according to certain embodiments of the present disclosure;

FIG. 4 illustrates one embodiment of a daisy-chain configuration of multiple intrusion detection devices, according to certain embodiments of the present disclosure;

FIG. 5 illustrates an example computer system that may be used for one or more portions of the example systems of FIGS. 1 and 2, according to certain embodiments of the present disclosure; and

FIG. 6 illustrates an example intrusion detection method, according to certain embodiments of the present disclosure.

### DETAILED DESCRIPTION OF EXAMPLE EMBODIMENTS

Line-replaceable units (LRUs) are systems or groups of components that may be replaced quickly and in many cases, with minimal effort or tools. For example, government organizations may deploy LRUs such as sensor units that monitor the air at various locations for biological and/or chemical agents. In many cases, LRUs include components such as circuit boards that may be removed and/or tampered with by unauthorized personnel. For example, an enemy may gain access to an LRU and remove and/or disable circuit boards in the LRU in order to gain a tactical advantage or to copy technology incorporated into the LRU.

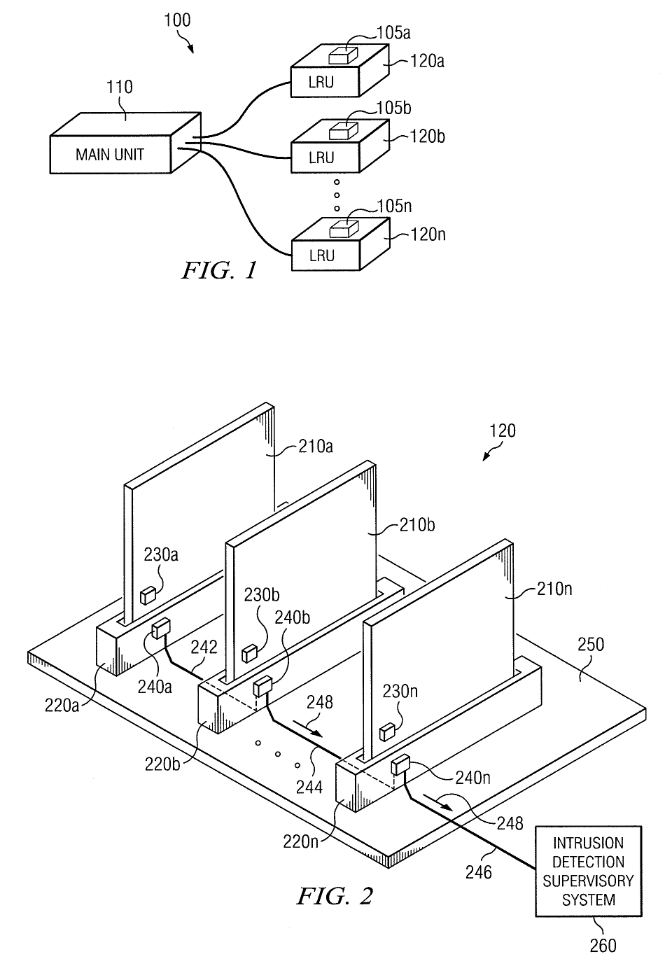

The teachings of the disclosure recognize that it would be desirable to provide a magnetic field activated intrusion detection system that discretely detects when a component or system is accessed or compromised. Although protection of particular types of systems is primarily described, the disclosure anticipates the disclosed intrusion detection systems being implemented with any appropriate system or component. FIGS. 1 through 6 below illustrate a magnetic field activated intrusion detection system according to the teachings of the disclosure.

FIG. 1 illustrates one embodiment of a system 100 in which an intrusion detection system 105 may be implemented, according to the teachings of the disclosure. System 100 includes a main unit 110 and one or more LRUs 120. In some embodiments, LRUs 120 may be directly coupled to main unit 110. In other embodiments, LRUs 120 may be coupled to main unit 110 through other components or systems including, but not limited to, any communication network.

LRUs 120 may be deployed at any location and may communicate with main unit 110. In one example, LRUs 120 may be computer systems. In another example, LRUs 120 may be sensor units that are deployed at various locations and communicate with main unit 110 located at a central command center. In this example, LRUs 120 may monitor the air for various agents such as biological or chemical agents. When an agent is detected by a particular LRU 120, it communicates information regarding the detection of the agent back to main unit 110. A particular embodiment of an LRU 120 is described in more detail below with reference to FIG. 2.

FIG. 2 illustrates one embodiment of an LRU 120 of system 100 in which intrusion detection system 105 may be utilized. In this embodiment, LRU 120 includes one or more circuit boards 210, circuit board connectors 220, and a backplane 250. Intrusion detection system 105 includes magnetic devices 230, intrusion detection devices 240, and an intrusion detection supervisory system 260. Circuit board connectors 220 are coupled to backplane 250, and circuit boards 210 include connectors (not illustrated) that enable circuit cards 210 to be plugged into circuit board connectors 220. Each circuit board 210 includes a magnetic device 230 that is proximate to an associated intrusion detection device 240 when the circuit card 210 is plugged into circuit board connector 220. Herein “proximate” may refer to any predetermined distance in which intrusion detection device 240 may detect a magnetic field generated by magnetic device 230. Intrusion detection devices 240 may be located any suitable location on backplane 250 or circuit board connectors 220.

Magnetic device 230 may be any material or object that produces a magnetic field. In some embodiments, magnetic device 230 is a permanent magnet. In some embodiments, magnetic device 230 is an electromagnet. A magnetic device 230 may be positioned anywhere on a circuit board 210 such that the magnetic field produced by the magnetic device 230 may be detected by an appropriate intrusion detection device 240 when the circuit board 210 is plugged into an associated circuit board connector 220.

Intrusion detection supervisory system 260 may be any system or component that communicates with intrusion detection devices 240 to detect when circuit boards 230 are removed from circuit board connectors 220. In some embodiments, intrusion detection supervisory system 260 may be located in a particular LRU 120. In some embodiments, intrusion detection supervisory system 260 may be located in main unit 110. Intrusion detection supervisory system 260 may be any hardware component, firmware, software, or computing system.

LRU 120 may include any number of circuit boards 210, circuit board connectors 220, associated intrusion detection devices 240, and magnetic devices 230. When LRU 120 includes multiple circuit boards 210 and circuit board connectors 220, intrusion detection devices 240 may be coupled in a daisy-chain fashion as illustrated. For example, intrusion detection device 240a may be coupled to intrusion detection device 240b via line 242, intrusion detection device 240b may be coupled to intrusion detection device 240n via line 244, and so forth. The last intrusion detection device 240 on backplane 250 may be coupled to intrusion detection supervisory system 260 via line 246. As a result, intrusion detection supervisory system 260 may detect when any of circuit boards 230 are removed from circuit board connectors 220.

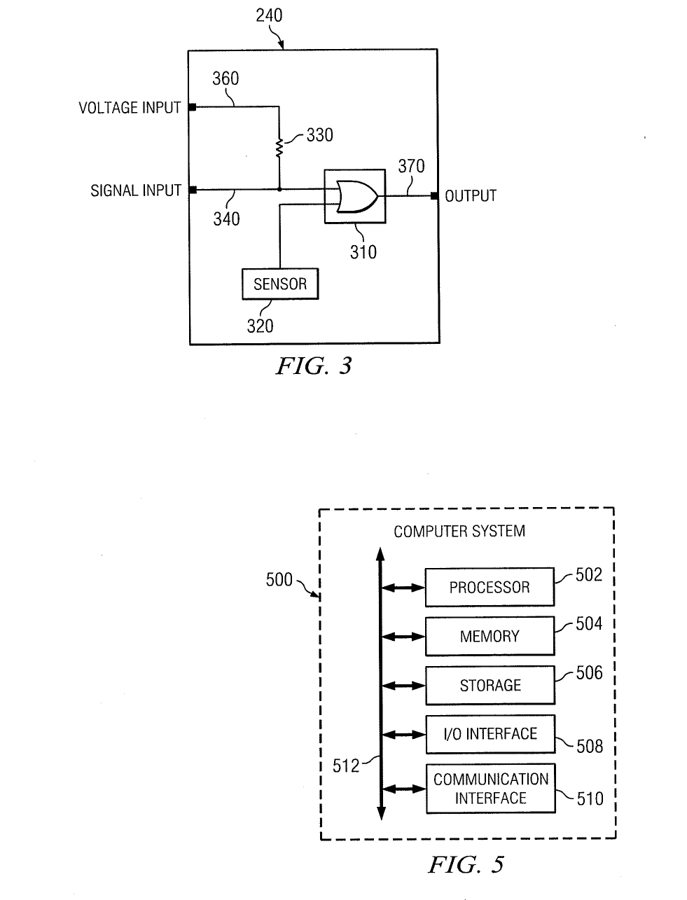

In operation, magnetic device 230 produces a magnetic field that is detected by an appropriate intrusion detection device 240 when the circuit board 210 is plugged into an associated circuit board connector 220. For example, when circuit board 210b is plugged into circuit board connector 220b, intrusion detection device 240b is operable to detect a magnetic field produced by magnetic device 230b. If circuit board 210b is removed from circuit board connector 220b or moved in any manner relative to circuit board connector 220b, intrusion detection device 240b generates a tamper detection signal 248 on line 244 to indicate that circuit board 210b has been tampered with. A particular embodiment of an intrusion detection device 240 is illustrated below with reference to FIG. 3.

Intrusion detection supervisory system 260 continually monitors the outputs of intrusion detection devices 240 for the presence of tamper detection signal 248 in order to detect any tampering with any of circuit boards 210 or to detect at first power up any tampering with any of circuit boards 210 while power was off. Upon detection of tamper detection signals 248, intrusion detection supervisory system 260 may perform any suitable function to record, report, and/or respond to the detection. In certain embodiments, for example, intrusion detection supervisory system 260 may store the tamper detection signal 248 for use by authorized personnel at a later time. In certain embodiments, intrusion detection supervisory system 260 may perform a punitive measure in response to receiving tamper detection signal 248. For example, intrusion detection supervisory system 260 may erase certain software or firmware stored in memory of the LRU 120 or the circuit board 210 that generated the tamper detection signal 248. Examples of software that may be erased by intrusion detection supervisory system 260 may include data files, software applications used by LRU 120 or circuit board 210, and/or firmware that may be stored in non-volatile storage of LRU 120 or circuit board 210. In certain embodiments, intrusion detection supervisory system 260 may physically destroy or harm certain components in the LRU 120 or circuit board 210 using techniques such as injecting excess voltage levels into the components in order to destroy them or render them non-functional.

In certain embodiments, intrusion detection devices 240 may be configured to detect tampering with components other than circuit boards. For example, intrusion detection devices 240 may be configured to detect tampering with individual circuit elements, such as integrated circuit (IC) devices and/or self-contained modules, such as power supplies that may be housed in a housing separate from other components of LRU 120.

In certain embodiments, intrusion detection device 240, magnetic device 230, and intrusion detection supervisory system 260 may be implemented with devices other than LRUs 120. For example, intrusion detection device 240, magnetic device 230, and intrusion detection supervisory system 260 may be utilized in a firearm to detect the tampering with any components of the firearm such as its receiver, trigger, safety mechanism, and/or one or more other critical components of the firearm. In some embodiments, intrusion detection supervisory system 260 may perform a punitive measure in response to the detection of the tampering with any components of a firearm. For example, intrusion detection supervisory system 260 may disable the firearm from further use upon detection of a tamper detection signal 248 from intrusion detection device 240 within the firearm.

Certain embodiments of the present disclosure may provide one or more technical advantages. For example, certain embodiments of the system 100 that sense tampering using changes in magnetic fields may provide advantages over other tamper detection devices. Many known tamper detection devices use door switches or other mechanically activated switching mechanisms that detect physical changes in their associated structures in order to detect tampering. These devices, however, may be susceptible to defeat by inhibiting actuation of the physical switch prior to movement of its associated component. Moreover, these mechanically activated switching mechanisms may be readily detectable using non-invasive imaging systems, such as X-ray imaging systems that may detect their presence without physically accessing the components with which they are associated. Once detected, a mechanically activated switching mechanism may be disabled, for example, by drilling into the enclosure housing the components and then subsequently applying an inhibiting substance, such as adhesive, to the mechanically activated switching mechanism such that it becomes disabled.

Certain embodiments of the present disclosure, however, may provide one or more technical advantages over prior systems. For example, certain embodiments of the intrusion detection devices 240 that sense tampering using changes in magnetic fields may provide advantages over other tamper detection devices that utilize mechanically activated switching mechanisms. Intrusion detection devices 240 according to the teachings of the present disclosure may provide an advantage over mechanically activated switching mechanisms in that intrusion detection devices 240 may be more difficult to differentiate from other components typically found in LRU 120. In some embodiments, intrusion detection devices 240 may not be disabled by merely drilling and applying adhesive to inhibit its operation.

FIG. 3 illustrates a particular embodiment of intrusion detection device 240 that may be utilized in an LRU 120 of system 100. Intrusion detection device 240 includes a cascading circuit 310, a magnetic field activated sensor 320, and a pull-up resistor 330 coupled as shown. Cascading circuit 310 includes an output signal line 370 and two inputs: input signal line 340 and input 345 from magnetic field activated sensor 320. Magnetic field activated sensor 320 may be additionally coupled to ground or a voltage source as needed. Pull-up resistor 330 is coupled to a voltage input 360 as shown. In embodiments where input signal line 340 is an active-low signal, voltage input 360 may be any voltage greater than 0 (e.g., 5.0 v, 3.3 v, 1.8 v, etc.). In embodiments where input signal line 340 is an active-high signal, voltage input 360 may be coupled to ground 380.

Intrusion detection device 240 may be packaged in any suitable form. In certain embodiments, each intrusion detection device 240 may be packaged in a surface mount device, such as a small outline transistor (SOT) type package. In some embodiments, intrusion detection device 240 may be hidden and/or camouflaged in any suitable way to avoid detection. For example, intrusion detection device 240 may be physically located anywhere where it is hidden from view, or it may be packaged in any way to resemble other common components on backplane 250 or circuit board connector 220.

Cascading circuit 310 may include any suitable circuitry that generates an active signal on output signal line 370 when an active signal is presented on either of input signal line 340 or input 345. For example, in embodiments where input signal line 340 and input 345 are active-high signals, cascading circuit 310 may include an OR gate (as illustrated) that produces a logic ‘1’ on output signal line 370 if a logic ‘1’ is presented at either input signal line 340 or input 345b. In embodiments where input signal line 340 and input 345 are active-low signals, cascading circuit 310 may include a Boolean NAND gate with an inverter at its output that produces a logic ‘0’ on output signal line 370 if a logic ‘0’ is presented at either input signal line 340 or input 345b. In certain embodiments, cascading circuit 310 may include circuitry, such as an AND gate having multiple inputs that are each individually coupled to an output signal line 370 of two or more magnetic field activated sensors 320.

Magnetic field activated sensor 320 may be any device that detects the magnetic field from magnetic device 230 and detects changes in the magnetic field due to any movement of the circuit board 210 that the magnetic device 230 is coupled to. In certain embodiments, magnetic field activated sensor 320 may include a magnetometer or a Hall effect device that detects changes in flux density of magnetic device 320 (e.g., when magnetic device 320 is a magnetic flux generator, such as a permanent magnet). In some embodiments, magnetic device 320 may be a magnetic device from NVE CORPORATION. In certain embodiments, -magnetic field activated sensor 320 may include a magnetic flux generator, such as a permanent magnet or electro-magnet. In such an embodiment, the magnetic flux density changes due to movement relative to magnetic device 230, which may be any material with a relatively high level of magnetic permeability.

Certain embodiments of magnetic field activated sensor 320 may include an architecture that stores a tamper detection signal that may be generated while LRU 120, cascading circuit 310, and/or intrusion detection supervisory system 260 are unpowered or are in an ‘off’ state. For example, magnetic field activated sensor 320 may have a structure that functions in a hysteresis loop to store changes in flux density provided by movement of magnetic device 230. Thus, the hysteresis loop may store the detected change in magnetic flux even in the absence of external power. At a later time when power is applied, cascading circuit 310 and intrusion detection supervisory system 260 may receive and process this stored tamper detection signal and take appropriate measures as described herein.

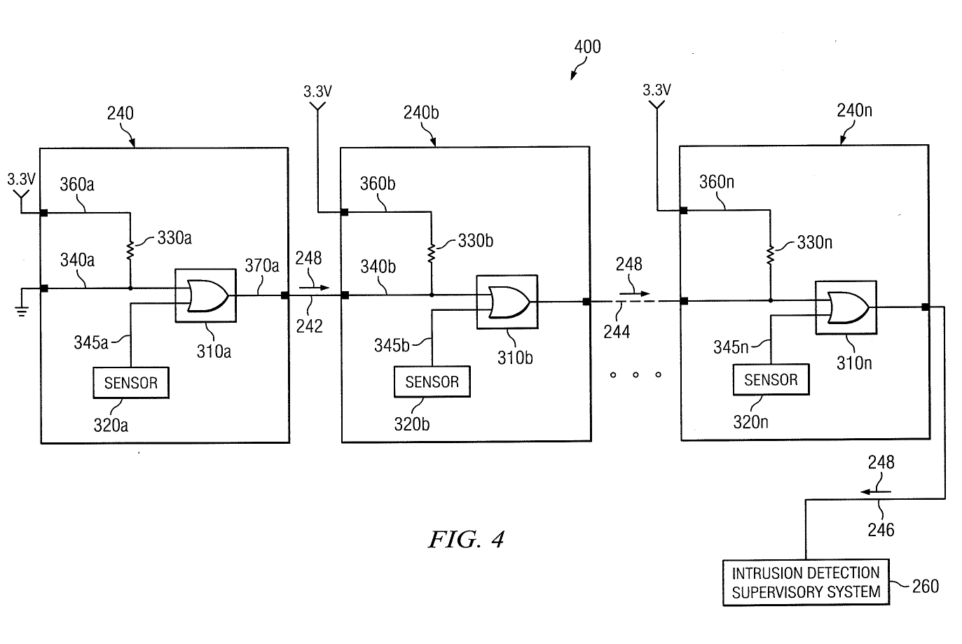

FIG. 4 illustrates an embodiment of the intrusion detection devices 240 of FIG. 2. The embodiment of FIG. 4 illustrates intrusion detection devices 240 cascaded together in a daisy-chain fashion with one or more other intrusion detection devices 240 such that tampering with any one circuit board 210 causes tamper detection signal 248 to be transmitted to intrusion detection supervisory system 260. In the daisy-chain configuration shown, input signal line 340b of intrusion detection device 240b receives any tamper detection signal 248 across line 242 from output 370a of intrusion detection device 240a. Likewise, input signal line 340n of intrusion detection device 240n receives any tamper detection signal 248 across line 244 from output 370b of intrusion detection device 240b. Each cascading circuit 310 receives output 370 from the previous intrusion detection device 240 in the chain and will generate an active signal on its local output 370 if either the output from the previous intrusion detection device 240 or input 345 from its local magnetic field activated sensor 320 is active. In this manner, multiple tamper detection signals 248 provided by multiple intrusion detection devices 240 may be combined into a single tamper detection signal 248 that is transmitted to intrusion detection supervisory system 260.

As an example for illustrative purposes, consider a situation in which only circuit card 210a of LRU 120 is tampered with. In this situation, a change in the magnetic field produced by magnetic device 230a is detected by magnetic field activated sensor 320a. As a result, an active-high signal is presented on input 345a and detected by cascading circuit 310a. Cascading circuit 310a, which in this example includes a logic OR gate, in turn produces an active-high signal on output 370a, which is illustrated in the example embodiment as tamper detection signal 248 across line 242. Tamper detection signal 248 on line 244 is detected at input signal line 340b of intrusion detection device 240b. Cascading circuit 310b, which includes a logic OR gate, detects the active-high signal on input signal line 340b and produces an active-high signal on output 370b, which is illustrated in the example embodiment as tamper detection signal 248 across line 244. In a similar manner, tamper detection signal 248 is propagated through any remaining intrusion detection devices 240 (such as intrusion detection device 240n) until it ultimately reaches intrusion detection supervisory system 260 via line 246.

As another example, consider a situation in which both circuit cards 210a and 210b of LRU 120 are tampered with. In this situation, a change in the magnetic field produced by magnetic device 230a is detected by magnetic field activated sensor 320a. As a result, an active-high signal is presented on input 345a and detected by cascading circuit 310a. Cascading circuit 310a, which in this example includes a logic OR gate, in turn produces an active-high signal on output 370a, which is illustrated in the example embodiment as tamper detection signal 248 across line 242. Tamper detection signal 248 on line 244 is detected at input signal line 340b of intrusion detection device 240b. In addition, a change in the magnetic field produced by magnetic device 230b is detected by magnetic field activated sensor 320b. As a result, an active-high signal is presented on input 345b. Cascading circuit 310b, which also includes a logic OR gate, detects the active signals on both input signal line 340b and input 345b and produces an active-high signal on output 370b, which is illustrated in the example embodiment as tamper detection signal 248 across line 244. Tamper detection signal 248 may then be propagated through any remaining intrusion detection devices 240 until it ultimately reaches intrusion detection supervisory system 260 via line 246.

Certain embodiments of the present disclosure may provide one or more technical advantages. For example, certain embodiments having multiple intrusion detection devices 240 coupled together in daisy-chain fashion may provide certain advantages. For example, attempts to inhibit any one particular intrusion detection device 240 may result in ‘breaking’ the chain such that intrusion detection supervisory system 260 still receives tamper detection signal 248 due to functionality provided by pull-up resistor 330. As another example, the daisy-chain configuration may provide relatively easy addition of new circuit boards 210 and/or replacement of circuit boards 210 with other circuit boards 210 during the serviceable life of LRU 120 without undue burden upon the design of system 100.

Modifications, additions, or omissions may be made to the disclosed systems without departing from the scope of the invention. The components of system 100 may be integrated or separated. For example, cascading circuit 310, magnetic field activated sensor 320, and pull-up resistor 330 may be integrally formed on a single monolithic integrated circuit chip, or formed of individual discrete components. Moreover, the operations of system 100 may be performed by more, fewer, or other components. For example, magnetic field activated sensor 320 may include additional circuitry that biases its magnetic flux sensing elements in a manner to ensure an appropriate level of sensitivity to magnetic flux changes. Additionally, operations of intrusion detection supervisory system 260 may be performed using any suitable logic comprising software, hardware, and/or other logic. As used in this document, “each” refers to each member of a set or each member of a subset of a set.

FIG. 5 illustrates an example computer system 500 that may be used for one or more portions of the example system 100 of FIG. 1, according to certain embodiments of the present disclosure. For example, portions or all of main unit 110, LRU 120, and intrusion detection supervisory system 260 may be implemented using all of the components, or any appropriate combination of the components, of computer system 500 described below. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer, or a combination of two or more of these. Where appropriate, computer system 500 may include one or more computer systems 500; be unitary or distributed; span multiple locations; span multiple machines; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a data bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. The present disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. The present disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Data bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes RAM. This RAM may be volatile memory, where appropriate. Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include an HDD, a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes ROM. Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide-area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, data bus 512 includes hardware, software, or both coupling components of computer system 500 to each other. As an example and not by way of limitation, data bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Data bus 512 may include one or more data buses 512, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk drive (HDD), a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 502 (such as, for example, one or more internal registers or caches), one or more portions of memory 504, one or more portions of storage 506, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

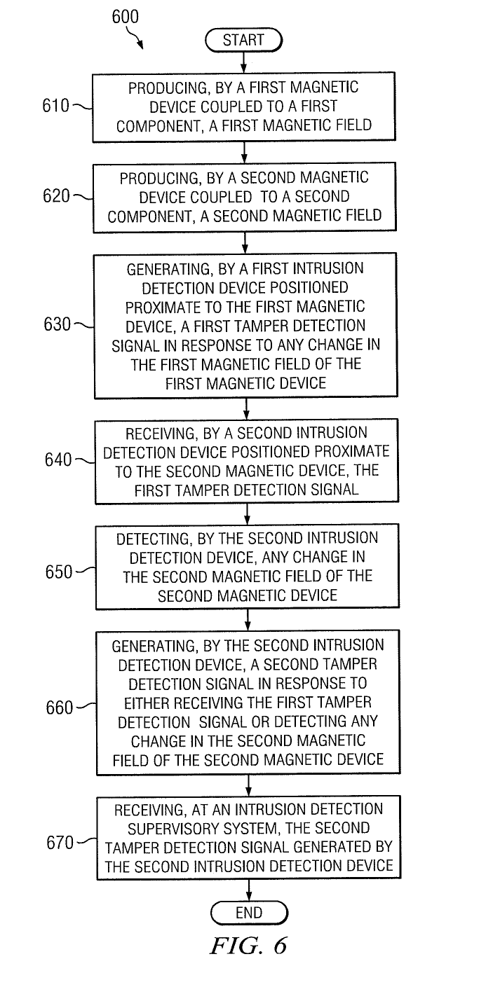

FIG. 6 illustrates an example embodiment of an intrusion detection method 600. Method 600 begins in step 610 where a first magnetic field is produced by a first magnetic device that is coupled to a first component. In some embodiments, the first magnetic device refers to a magnetic device 230 such as magnetic device 230a described above.

In step 620, a second magnetic field is produced by a second magnetic device that is coupled to a second component. In some embodiments, the second magnetic device refers to a magnetic device 230 such as magnetic device 230b described above.

In step 630, a first tamper detection signal is generated by a first intrusion detection device positioned proximate to the first magnetic device in response to any change in the first magnetic field of the first magnetic device. In some embodiments, the first intrusion detection device may refer to an intrusion detection device 240 such as intrusion detection device 240a described above. In some embodiments, the first tamper detection signal may refer to tamper detection signal 248 described above.

In step 640, the first tamper detection signal of step 630 is received by a second intrusion detection device positioned proximate to the second magnetic device. In some embodiments, the second intrusion detection device may refer to an intrusion detection device 240 such as intrusion detection device 240b described above.

In step 650, any change in the second magnetic field of the second magnetic device is detected by the second intrusion detection device. In step 660, a second tamper detection signal is generated by the second intrusion detection device in response to either receiving the first tamper detection signal or detecting any change in the second magnetic field of the second magnetic device. In some embodiment, the second intrusion detection device utilizes a logic OR gate or a logic NAND gate with an inverter at its output as described above.

In step 660, the second tamper detection signal generated by the second intrusion detection device is received at an intrusion detection supervisory system. In some embodiments, the intrusion detection supervisory system refers to intrusion detection supervisory system 260 described above. After step 660, method 600 ends.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An intrusion detection system, comprising:
a plurality of intrusion detection devices, each intrusion detection device corresponding to one of a plurality of components, each intrusion detection device comprising:
a magnetic field activated sensor operable to:
detect movement of its corresponding component by sensing a magnetic flux variation of a magnetic device coupled to the corresponding component; and
generate a signal indicating that the corresponding component has moved; and
a cascading circuit, comprising:
a first input coupled to the magnetic field activated sensor and operable to receive the signal generated by the magnetic field activated sensor indicating that the corresponding component has moved; and
a second input coupled to another cascading circuit of another intrusion detection device;
the cascading circuit operable to generate a tamper detection signal if the signal indicating that the corresponding component has moved is received at the first input or if another tamper detection signal generated by the other intrusion detection device is received at the second input.

2. The intrusion detection system of claim 1, wherein the plurality of components comprises a plurality of circuit boards of a computer system.

3. The intrusion detection system of claim 1, wherein the plurality of components comprise components of a firearm.

4. The intrusion detection system of claim 1, wherein the cascading circuit comprises a logic OR gate.

5. The intrusion detection system of claim 1, wherein the magnetic device comprises a permanent magnet.

6. The intrusion detection system of claim 1, wherein the magnetic field activated sensor comprises a magnetometer.

7. The intrusion detection system of claim 1, further comprising an intrusion detection supervisory system operable to receive the tamper detection signal.

8. An intrusion detection system, comprising:
a first magnetic device coupled to a first component and operable to produce a first magnetic field;
a second magnetic device coupled to a second component and operable to produce a second magnetic field;
a first intrusion detection device positioned proximate to the first magnetic device, the first intrusion detection device operable to detect the first magnetic field of the first magnetic device and in response to a change in the first magnetic field, generate a first tamper detection signal;
a second intrusion detection device positioned proximate to the second magnetic device, the second intrusion detection device operable to:
receive the first tamper detection signal;
detect the second magnetic field of the second magnetic device; and
generate a second tamper detection signal in response to either receiving the first tamper detection signal or a change in the second magnetic field of the second magnetic device; and
an intrusion detection supervisory system operable to receive the second tamper detection signal generated by the second intrusion detection device.

9. The intrusion detection system of claim 8, wherein the first and second components comprise circuit boards of a computer system.

10. The intrusion detection system of claim 8, wherein the first and second components comprise components of a firearm.

11. The intrusion detection system of claim 8, wherein the first and second magnetic devices comprise permanent magnets.

12. The intrusion detection system of claim 8, wherein second intrusion detection device comprises:
a magnetic field activated sensor operable to:
detect movement of the second magnetic device by sensing a magnetic flux variation of the second magnetic device; and
generate a signal indicating that the second magnetic device has moved; and
a cascading circuit, the cascading circuit operable to:
receive the signal generated by the magnetic field activated sensor indicating that the second magnetic device has moved; and
generate the second tamper detection signal if the signal indicating that the second component has moved is received or if the first tamper detection signal is received by the cascading circuit.

13. The intrusion detection system of claim 12, wherein the cascading circuit comprises a logic OR gate.

14. The intrusion detection system of claim 8, wherein the magnetic field activated sensor comprises a magnetometer.

15. An intrusion detection method, comprising:
producing, by a first magnetic device coupled to a first component, a first magnetic field;
producing, by a second magnetic device coupled to a second component, a second magnetic field;
generating, by a first intrusion detection device positioned proximate to the first magnetic device, a first tamper detection signal in response to a change in the first magnetic field of the first magnetic device;
receiving, by a second intrusion detection device positioned proximate to the second magnetic device, the first tamper detection signal;
detecting, by the second intrusion detection device, a change in the second magnetic field of the second magnetic device;
generating, by the second intrusion detection device, a second tamper detection signal in response to either receiving the first tamper detection signal or detecting a change in the second magnetic field of the second magnetic device; and
receiving, at an intrusion detection supervisory system, the second tamper detection signal generated by the second intrusion detection device.

16. The intrusion detection method of claim 15, further comprising storing, by the intrusion detection supervisory system, the received second tamper detection signal.

17. The intrusion detection method of claim 15, further comprising performing, by the intrusion detection supervisory system, a punitive measure in response to receiving the second tamper detection signal.

18. The intrusion detection method of claim 17, wherein the punitive measure comprises erasing software or firmware.

19. The intrusion detection method of claim 17, wherein the punitive measure comprises physically harming one or more devices.

20. The intrusion detection method of claim 15, wherein the first and second components comprise circuit boards of a computer system.
